(19) United States
(12) Patent Application Publication
(10) Pub. No.: US 2006/0132529 A1
(43) Pub. Date: Jun. 22, 2006

(54) Positioning system

(76) Inventors: Bart Verhoest, Niel (BE); Dirk Verdyck, Merksem (BE)

Correspondence Address: AGFA CORPORATION;LAW & PATENT DEPARTMENT, 200 BALLARDVALE STREET, WILMINGTON, MA, 01887, US

(21) Appl. No.: 11/284,331

(22) Filed: Nov. 21, 2005

Related U.S. Application Data
(60) Provisional application No. 60/648,022, filed on Mar. 4, 2005.

(30) Foreign Application Priority Data
Dec. 22, 2004 (EP) 04106837.0
Jun. 7, 2005 (EP) 05104914.6

(51) Int. Cl. B41J 29/393

(52) U.S. Cl. 347/19

(57) ABSTRACT

A positioning system includes adjustment means for accurately positioning a positioning device relative to a frame. The adjustment means makes a sliding contact with a dedicated lever which makes contact with the frame. The contact surfaces of the dedicated lever are specially shaped in order to obtain a linear behavior of the positioning system. Within a working distance D an equal movement of the adjustment means over a distance Δx is converted into a corresponding movement of the positioning device relative to the frame over a distance Δy. The ratio Δx/Δy is substantially constant for movements within the working distance D. When using the positioning system in a printing system, it is possible to measure the position error of printheads having arrays of printing elements only once and adjust the positioning devices carrying the printheads only once to align the printing elements to each other and to the printing direction of the printer.

The application claims the benefit of U.S. Provisional Application No. 60/648,022 filed Mar. 4, 2005.

The present invention relates to a positioning system for positioning an element relative to a frame. More specifically a positioning system which can be used in a dot matrix printing system for positioning printheads relative to a mounting frame or base plate and to each other.

### BACKGROUND OF THE INVENTION

When using a printing technique that puts down marking material, e.g. ink, on a receiving substrate in a matrix form, the image to be produced is rendered before it is printed. Rendering creates a representation of the image as a matrix of individual marking points in such a way that printing the individual marking point at their correct matrix position resembles the original image as close as possible. In the final printed image the position of the individual marking points is crucial to the quality of the image. Any errors in the position of the printed marking points on the receiving substrate from their position assumed in the rendering process, shows up in the printed image. Marking points being too close to each other show macroscopically as an area that has received too much marking material than it should have; marking points being too far separated show macroscopically as an area that has received too little marking material than it should have. When positional errors become systematic, they can show as stripes in the printed image. Of primary importance in controlling the position where the marking material is printed, is the position of the printing head providing the marking material via a plurality of marking elements. In scanning printing systems, color printing systems or printing systems using butted heads, the printing heads needs to be positioned and aligned correctly with respect to each other and with respect to the receiving substrate. This to ensure a correct superposition of the color separated images and good fitting of the image bands printed by each printhead.

In patent application WO 01/60 627 from Xaar, herein incorporated by reference in its entirety for background information only, the printing heads are adjustably mounted on a single base plate. The position of each printing head can be adjusted with reference to a datum on the base plate. All printing heads are positioned with reference to the same datum so that they can all be aligned properly. The base plate itself is positioned against datums on the printer body so that finally the position of the marking elements of the printing heads relative to the printer body is known at all times. The positioning of printing heads relative to datums fixed on a carriage or printer body is commonly known.

In patent application WO 01/60 627 the alignment is done via specially shaped screws that drive the printing heads against specially shaped features on the base plate.

Aligning the printing heads is an iterative process because it required a test print after each screw adjustment to see the effect of the adjustment on the print result. This needs to be repeated until perfect alignment is achieved. Therefore the alignment of printing heads after printer installation or after printing head replacement is a tedious work and is often performed by the printer manufacturer or install/service team, but seldom by the printer operator.

Printhead mounting systems sometimes include a printhead holding device which is rigidly mounted on a base plate and wherein a printhead is adjustably mounted. The printhead has to be clamped in a secure way in the printhead holding device while at the same time the printhead itself should be accurately positionable within the device. These goals are not always compatible to each other.

Positioning screws are sometimes hardly accessible as these are mounted close to the base plate. This provides further difficulties in the tedious adjustment of the printheads. Certain inkjet printing systems include up to eight different printheads in a small space and aligning the different heads in the three dimensions requires a considerable effort.

Another problem is that forces acting on the adjustment screws can include a transversal component, i.e. the screw is not only pushed upwards but also sideways due to an oblique butting contact to a surface.

Relative large sideways forces can act on the screws. Especially for a high precision alignment system this should be avoided as this can lead to premature wear leading to play in the system resulting in inaccurate positioning.

It is clear that there is a need for a cheap, easy and reliable positioning system for positioning e.g. used for positioning a printhead. When adjustments are made the displacement should be predictable, so that deviation of the printheads only needs to be measured and adjusted once. The design should have a inherent property that transversal forces are avoided.

### SUMMARY OF THE INVENTION

The above-mentioned advantageous effects are realized by a positioning system having the specific features set out in claim 1. Specific features for preferred embodiments of the invention are set out in the dependent claims.

Further advantages and embodiments of the present invention will become apparent from the following description and drawings.

### BRIEF DESCRIPTION OF THE DRAWINGS

FIGS. 1A, 1B, 1C show the behavior of an ideal lever.

FIGS. 2A and 2B illustrate the existence of a singular point.

FIGS. 3A and 3B illustrate the migration of the contact point on the force arm of the lever.

FIGS. 4A and 4B illustrate the migration of the contact point on the load arm of the lever.

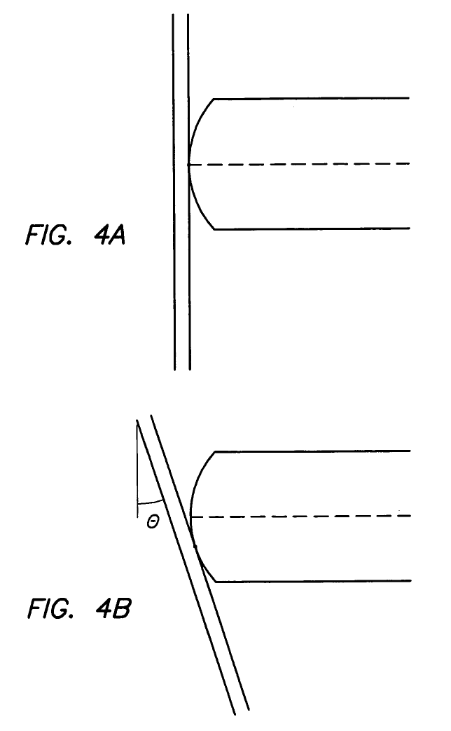

FIGS. 5A and 5B illustrate the contact point migration when using a segment of a circle as contact area on the lever.

FIG. 6 depicts a general case of a solid body defined by boundary function in a certain rotational position θ.

FIGS. 7A and 7B give the ideal forms of the contact surfaces of the lever according to an embodiment of the present invention wherein the contact points remain at fixed positions.

FIG. 8 gives the deviation from linearity of a lever according to the present invention.

FIG. 9 gives the deviation from linearity of the lever using segments of a circle as contact surface.

FIGS. 10A and 10B give the ideal forms of the contact surfaces of the lever according to an embodiment of the present invention with moving contact points.

FIG. 11 gives an printhead holding device using a position system according to the present invention.

FIG. 12 illustrates that by translation of the marking elements due to rotation of the head positioning device can be avoided by having the rotation point slide along the x-axis.

### DETAILED DESCRIPTION OF THE PREFERRED EMBODIMENTS

While the present invention will hereinafter be described in connection with preferred embodiments thereof, it will be understood that it is not intended to limit the invention to those embodiments.

The invention provides a positioning system that allows for mounting an element in a positioning device which can be accurately positioned relative to a frame carrying the positioning device, e.g. the printing head in a printing apparatus is mounted in a printhead positioning device which can be accurately aligned to a base plate carrying the positioning device. The positioning system according to the invention also avoids exerting excessive lateral forces onto the adjustment elements.

The positioning system provides a proportional relationship between a displacement of the adjustment means, easily accessible to the operator, and the movement in the position of the positioning device relative to the frame.

Due to a proportional relationship between the movement Δx of the adjusting means and the displacement Δy of the positioning device, a reliable, accurate and predictable adjustment can be performed. Once an alignment error is known, a single adjustment can give a perfect alignment.

The proportional relationship is guaranteed by a dedicated lever mechanism meeting a number of geometric constraints with respect to the shape of the lever, especially the contact surfaces on which the forces on the lever act, and the orientation of the interface surface between lever and acting force and base plate. Using the dedicated lever mechanism a rotation of an adjustment screw on the head positioning device is transformed into a linear displacement of the positioning device relative to a mounting base plate. The adjustment means are self-locking and have no backlash, securing the position of the printing head at all times.

Considerations Regarding the Working Conditions of a Lever

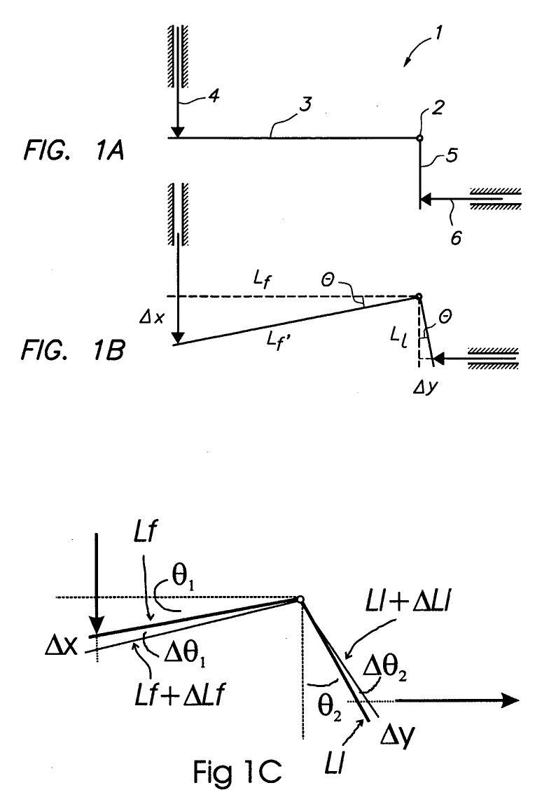

Let us consider an ideal lever, as shown in FIG. 1A, which could be used in a positioning system for positioning an positioning device relatively to a frame.

The lever 1 has a rotation point 2 which is a fixed point on the frame (or on the element to be positioned relatively to the frame), a force arm 3 at which force is exerted by an adjustment means 4 and a load arm 5 butting against the load 6 (element or the frame.)

As the lever is an ideal lever:
the contacts of the lever 1 with the adjustment means 4 and the load 6 are ideal point contacts; and
the surfaces of the force and load arms 3,5 are perfectly flat surfaces.

The forces of the adjustment means 4 and the load 6 are at the same angle relatively to the force and load arm 3,5.

A further restraint in the system is that the orientation of the adjustment means 4 and force of the load 6 is fixed. A practical design of the adjustment means 4 is the use of a screw which can regulate the height of the force lever 3. The load 6 can be an element to be positioned and which can slide along a rail mounted on the frame. Practical examples are given further below.

Referring to FIG. 1A, when the adjustment means 4 is adjusted over a distance Δx, the lever will rotate over an angle θ which is dependent upon the length Lf of the force arm. A force arm is defined as the perpendicular distance from the force to the rotation point.

$$Equation 1 \text{:}$$

$$θ = arc Tg \frac{Δ x}{Lf}$$

The rotation θ causes a displacement Δy of the load which is dependant upon the length or the load arm.

$$Equation 2 \text{:}$$

$$θ = arc Tg \frac{Δ y}{Ll}$$

And hence Δx/Δy=Lf/Ll which could be expected. The ratio of the displacement values depends on the ratio of the length of the force and load arms.

However, because the orientation and place of the adjustment means and load are fixed a consequence is that the length of the force and load arm will not change during the rotation, as the force arm is the perpendicular distance of the force to the rotation point. From FIG. 1B it can be seen that the force lever arm length will grow longer to value Lf′ and the load lever arm length will grow longer to Ll′, wherein Lf′=Lf/cos θ and Ll′=Ll/cos θ. The ratio of the lengths of the force (Lf) and load arm (Ll) will not change in these ideal conditions.

$$Equation 3 \text{:}$$

$$\frac{Lf}{Ll} == \frac{{Lf}^{′} \cdot cos θ}{{Ll}^{′} \cdot cos θ} = \frac{{Lf}^{′}}{{Ll}^{′}}$$

The displacement Δx of the adjustment device will always result in the same correcponding movement Δy.

If we take the more general case, as depicted in FIG. 1c, then we can try to write the exact relationship between Δx and Δy for a given rotation Δθ of the object. Consider a displacement of the first point at force lever from θ₁ to θ₁+Δθ. Due to the fact that we keep the force arm constant during this movement, we can write:

$$Equation 4 \text{:}$$

$$\{ \begin{matrix}Lf cos θ = ( Lf + Δ Lf ) cos ( {θ}_{f} + Δθ ) \\ Lf sin {θ}_{f} = ( Lf + Δ Lf ) sin ( {θ}_{f} + Δθ ) + Δy\end{matrix} .$$

From this equation, the term Lf-ΔLf can be removed so that we end up with a relationship between Δy as a function of Δθ:

$$Equation 5 \text{:}$$

$$Δ y = Lf \frac{sin Δθ}{cos ( {θ}_{f} + Δθ )} .$$

A similar equation can be found for Δx:

$$Equation 6 \text{:}$$

$$Δ x = Ll \frac{sin Δθ}{cos ( {θ}_{l} + Δθ )} .$$

We can then write the ratio of Δx/Δy for a straight contact surface as:

$$Equation 7 \text{:}$$

$$\frac{Δ x}{Δ y} = \frac{Ll}{Lf} \cdot \frac{cos ( {θ}_{f} + Δθ )}{cos ( {θ}_{l} + Δθ )} .$$

So, in order to have the ratio of Δx to Δy constant, for random values of θ_{f} and θ₁, this is only possible when of equals θ₁, or when the two lever arms are positioned relative to each other with a right angle. But we need another mandatory constraint and that is the fact that the forces should be perpendicular to the contact surface of the lever, which in practice will give a surface trajectory that is rather complex in order to fulfil both conditions. Therefore, in practice, due to the complex nature of these surfaces, the adjustment range of the adjustment means is to be restricted to a certain distance X as lever arms would become extremely long at great rotation angles.

Several problems can be encountered in reality when the lever is not the mathematical ideal lever.

Occurrence of Singular Points in the Operating Interval

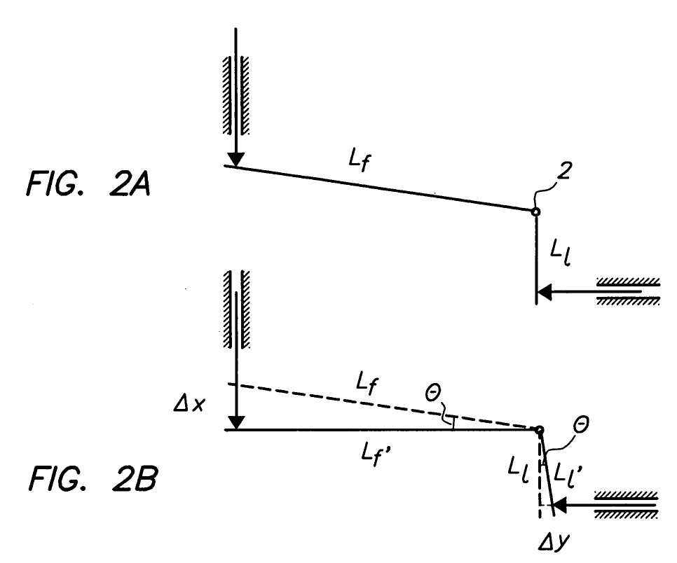

Under certain conditions the ratio of the force and load arm will change during rotation. Consider the situation depicted in FIG. 2A. The force of the adjustment means is at a different angle to the force arm than the angle of the load to the load arm.

During rotation, evaluating to the situation of FIG. 2B, it can be clearly seen that length of the force arm Lf has become shorter Lf′ over the rotation angle θ while the load arm Ll has grown larger Ll′ over the rotation θ.

A constant value for the ratio of the evolving lever arm lengths is clearly not satisfied in this example. A displacement of the adjustment means over an equal distance Δx will not result in a equal displacement Δy as the ratio of the force and load arms.

When rotating further the force arm will become longer again, but even if both arms grow longer the ratio of the force and load arm will still vary as the cosine function is not a linear function.

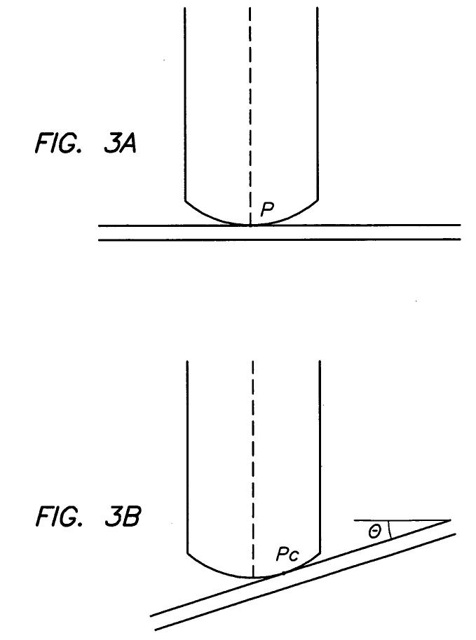

Another problem is that in a real situation the contact between the lever arm and the adjustment device/load is not a point contact. Clarification is given in relation to FIGS. 3A and 3B.

In FIG. 3A the contact of the regulating screw of the adjustment device is depicted while being in contact with the horizontal surface of the force arm of the lever. The contact point can be defined at the center of the regulating screw at the interface with the lever.

In FIG. 3B the situation is depicted while the lever force arm is at an angle θ. It is clear that the contact point has migrated a small distance in the direction of the rotation point of the lever, so the length of the force arm is a bit shorter than would be expected from the ideal situation as described above.

In 4A and 4B it can be seen that for the load arm the length of the load arm tends to be a bit longer than expected due to the rotation and the non-perfect contact.

Due to these imperfections the linear relationship between Δx and Δy is disturbed. In a micropositioning system such as used for positioning e.g. inkjet printhead this is not to be neglected. The non-linearity makes it impossible to predictably adjust the position of the element. Alignment without several newly printed test images is impossible.

Another drawback is that after rotation of the lever over an angle θ the forces acting upon the regulation screw are not parallel to the center line of the screw. The butting pressure does have a transversal component which is larger as the angle increases.

This also leads to possible variations in the positioning system and leads after time to play and imperfections in the adjustment system. It is to be desired that the contact between adjustment device/load and lever is to be close as possible to the ideal point contact.

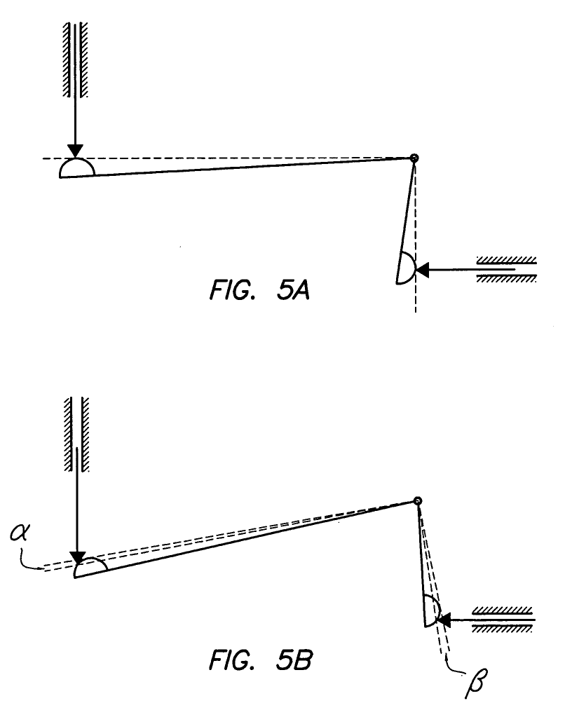

One method to obtain this point-like contact is by giving the lever used in the positioning system a curved surface. A possible solution shown in FIG. 5A is that the contact area of the lever is a segment of a circle. Then the resulting contact is more point-like but has another consequence.

Due to translation of the contact point over the curved surface of the lever during rotation as shown in FIG. 5B, the ratio of the length of the force arm and the length of the load arm can be kept constant, but also the lever angle between the force arm and load arm slightly changes as can be seen by the change of the contact lines with angles α and β, also influencing the relationship between Δx and Δy and making it non-linear.

Design of Lever Arm Contact Surfaces for Linear Operation

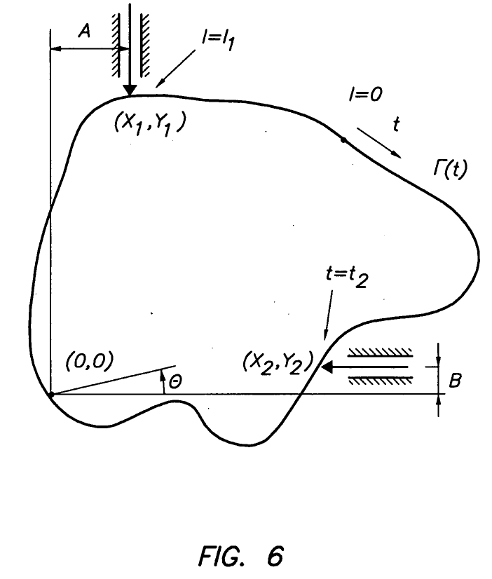

A more fundamental approach can be taken to obtain a linear relationship between Δx and Δy. Let's make a force analysis on a structure and let us apply the principle of virtual force. FIG. 6 gives the theoretical situation of a random structure which is controlled by forces. Note that in FIG. 6 Δx is associated with a displacement of the structure at the load position t=t2 in horizontal direction and Δy is associated with a displacement of the structure at the force position t=t1 in vertical direction, contrary to the use of Δx and Δy in the previous figures.

In a stationary situation, the forces acting on the structure should balance each other. Assuming that no torque is possible in the origin (0,0), the moment equation of the body gives the equation 8.
AF₁=BF₂[Nm] Equation 8

Suppose that in contact point t=t1, a small movement Δy1 is given, which will result in a movement Δx2 in contact point t=t2. Due to the principle of virtual work, the delivered energy will stay constant.
F₁Δy₁=F₂Δx₂[J] Equation 9

For the above equation to be correct, it is mandatory that both forces act on the surface in the same angle at the contact point. Also, during the movement, it is assumed that no friction force is present.

Substituting Equation 8 gives.

$$Equation 10 \text{:}$$

$$Δ {x}_{2} = \frac{B}{A} \cdot Δ {y}_{1} [ m ]$$

If the ratio of Δx₂/Δy₁ should stay constant, it is mandatory to keep the ratio B/A constant. So, this means that:
A. we make the type of the contact points so that they always stays at the distances A and B;
Or
B. we make the type of the contact points so that they shift in distance, but with a same ratio, meaning:

$$Equation 11 \text{:}$$

$$\frac{B}{A} = \frac{Bf ( θ )}{Af ( θ )} [ ] ,$$

with f(θ) a continues function of θ.

A. Kinematics for Contact Points Remaining at Fixed A and B Positions, i.e. Having Only One Degree of Freedom

With continued reference to FIG. 6, imagine the random structure or plane object having a boundary Γ, where each coordinate point of this boundary Γ can be described by the following function:

$$Equation 12 \text{:}$$

$${( \begin{matrix}x \\ y\end{matrix} )}_{Γ} = ( \begin{matrix}{Γ}_{x} ( t ) \\ {Γ}_{y} ( t )\end{matrix} )$$

The coordinate system has been taken in such a way that a pivot point exists at the origin of the axis system. So, the point (0,0) is a rotating point for the plane body and the rotational position of the plane body can be described uniquely by an angle θ. Assume also that the location of the boundary points in Equation 12 are defined for the angle θ being identical to zero. When θ is not zero, the coordinates of the boundary points can be found by a simple rotational transformation:

$$Equation 13 \text{:}$$

$${( \begin{matrix}x ( t , θ ) \\ y ( t , θ )\end{matrix} )}_{Γ} = ( \begin{matrix}cos θ & - sin θ \\ sin θ & cos θ\end{matrix} ) ( \begin{matrix}{Γ}_{x} ( t ) \\ {Γ}_{y} ( t )\end{matrix} )$$

This can be written also as:

$$Equation 14 \text{:}$$

$$\{ \begin{matrix}x ( t , θ ) = cos θ \cdot {Γ}_{x} ( t ) - sin θ \cdot {Γ}_{y} ( t ) \\ y ( t , θ ) = sin θ \cdot {Γ}_{x} ( t ) + cos θ \cdot {Γ}_{y} ( t )\end{matrix} .$$

At a certain boundary point (x₁,y₁) that can be found at the coordinate t₁ in a certain random angle position θ, a displacement is given of the form: (0,Δy), imposed by a thin rod, pushing against the boundary and also sliding in the x-direction over this boundary. What will be the angle rotation dθ of the plane object?

For an imposed displacement (0,Δy), the object will rotate and the contact point will shift from the position t₁ to a position t₁+dt.

$$Equation 15 \text{:}$$

$$\{ \begin{matrix}0 = dx ( {t}_{1} , θ ) = - sin θ \cdot {Γ}_{x} ( {t}_{1} ) \cdot d θ + cos θ \frac{ⅆ {Γ}_{x} ( {t}_{1} )}{ⅆ t} d t - cos θ \cdot {Γ}_{y} ( {t}_{1} ) d θ - sin θ \frac{ⅆ {Γ}_{y} ( {t}_{1} )}{ⅆ t} d t \\ Δ y = dy ( {t}_{1} , θ ) = cos θ \cdot {Γ}_{x} ( {t}_{1} ) \cdot d θ + sin θ \frac{ⅆ {Γ}_{x} ( {t}_{1} )}{ⅆ t} d t - sin θ \cdot {Γ}_{y} ( {t}_{1} ) d θ + cos θ \frac{ⅆ {Γ}_{y} ( {t}_{1} )}{ⅆ t} d t\end{matrix}$$

From this system of equation, the rotation dθ of the object can be solved by eliminating dt, as it is of no interest to us.

$$Equation 16 \text{:}$$

$$d θ = Δ y \frac{cos θ \frac{ⅆ {Γ}_{x} ( {t}_{1} )}{ⅆ t} - sin θ \frac{ⅆ {Γ}_{y} ( {t}_{1} )}{ⅆ t}}{\begin{matrix}( cos θ \cdot {Γ}_{x} ( {t}_{1} ) - sin θ \cdot {Γ}_{y} ( {t}_{1} ) ) ( cos θ \frac{ⅆ {Γ}_{x} ( {t}_{1} )}{ⅆ t} - sin θ \frac{ⅆ {Γ}_{y} ( {t}_{1} )}{ⅆ t} ) + \\ ( sin θ \cdot {Γ}_{x} ( {t}_{1} ) + cos θ \cdot {Γ}_{y} ( {t}_{1} ) ) ( sin θ \frac{ⅆ {Γ}_{x} ( {t}_{1} )}{ⅆ t} + cos θ \frac{ⅆ {Γ}_{y} ( {t}_{1} )}{ⅆ t} )\end{matrix}}$$

Let's try this equation. We take a simple boundary, being a straight line lying on the x-axis, so that the points of the boundary described by Equation 12 can be written as:

$$Equation 17 \text{:}$$

$${( \begin{matrix}x \\ y\end{matrix} )}_{Γ} = ( \begin{matrix}{Γ}_{x} ( t ) \\ {Γ}_{y} ( t )\end{matrix} ) = ( \begin{matrix}- t \\ 0\end{matrix} )$$

At t=t₁, we give a displacement Δy. The expected rotation dθ for θ=0 equals −Δy/t₁. When θ equals 90°, dθ is expected to be zero, as the contact point will simply shift over the boundary without any rotation of the body. We check this feeling by putting numbers into Equation 16.

First of all, notice that according to Equation 17, dΓₓ/dt=−1 and dΓ_{y}/dt=0. For θ=0, Equation 16 becomes:

$$d θ = Δ y \frac{- 1}{( - {t}_{1} ) ( - 1 ) + 0 \cdot 0} = - \frac{Δ y}{{t}_{1}} ,$$

which is correct and for θ=90°, Equation 16 becomes:

$$d θ = Δ y \frac{0}{0 \cdot 0 + ( - {t}_{1} ) ( - 1 )} = 0 ,$$

which is also correct.

Assume that the body pushes another rod at the boundary in a point (x₂,y₂), being described by the boundary coordinate t=t₂. Assume that the rod can move in the x-direction and that no friction is possible at the contact point in the y-direction. This results in a movement (Δx,0). For a given small body rotation dθ, the resulting displacement Δx has to be found.

For this displacement, Equation 15 can be rewritten as:

$$Equation 18 \text{:}$$

$$\{ \begin{matrix} Δ x = - sin θ \cdot {Γ}_{x} ( {t}_{2} ) \cdot d θ + cos θ \frac{ⅆ {Γ}_{x} ( {t}_{2} )}{ⅆ t} d t - cos θ \cdot {Γ}_{y} ( {t}_{2} ) \cdot d θ - sin θ \frac{ⅆ {Γ}_{y} ( {t}_{2} )}{ⅆ t} d t \\ 0 = cos θ \cdot {Γ}_{x} ( {t}_{2} ) \cdot d θ + sin θ \frac{ⅆ {Γ}_{x} ( {t}_{2} )}{ⅆ t} d t - sin θ \cdot {Γ}_{y} ( {t}_{2} ) \cdot d θ + cos θ \frac{ⅆ {Γ}_{y} ( {t}_{2} )}{ⅆ t} d t\end{matrix}$$

Eliminating the displacement dt over the boundary gives Δx as a function of dθ.

$$Equation 19 \text{:}$$

$$Δ x = - d θ [ \frac{\begin{matrix}( sin θ \cdot {Γ}_{x} ( {t}_{2} ) + cos θ \cdot {Γ}_{x} ( {t}_{2} ) ) ( sin θ \frac{ⅆ {Γ}_{x} ( {t}_{2} )}{ⅆ t} + cos θ \frac{ⅆ {Γ}_{y} ( {t}_{2} )}{ⅆ t} ) + \\ ( cos θ \frac{ⅆ {Γ}_{x} ( {t}_{2} )}{ⅆ t} - sin θ \frac{ⅆ {Γ}_{y} ( {t}_{2} )}{ⅆ t} ) ( cos θ \cdot {Γ}_{x} ( {t}_{2} ) - sin θ \cdot {Γ}_{y} ( {t}_{2} ) )\end{matrix}}{sin θ \frac{ⅆ {Γ}_{x} ( {t}_{2} )}{ⅆ t} + cos θ \frac{ⅆ {Γ}_{y} ( {t}_{2} )}{ⅆ t}} ]$$

Again, we check the equation with a simple example. Imagine a boundary defined by:

$$Equation 20 \text{:}$$

$${( \begin{matrix}x \\ y\end{matrix} )}_{Γ} = ( \begin{matrix}{Γ}_{x} ( t ) \\ {Γ}_{y} ( t )\end{matrix} ) = ( \begin{matrix}0 \\ t\end{matrix} )$$

When giving for θ=0 a rotation dθ, the expected Δx-displacement is −dθ·t, which can be found by proper substitution into Equation 19.

So far, we found the formulation for an incremental rotation dθ as the result of an imposed displacement Δy and the formulation for a load displacement Δx as the result of an incremental rotation dθ of the body. We take the calculated value of dθ in Equation 16, which gives us the resulting rotation for an imposed displacement Δy at t1, and substitute it in Equation 19 to calculate the displacement Δx at t2 for an imposed displacement Δy at t1. This gives Equation 21.

$$Equation 21 \text{:}$$

$$\begin{matrix}Δ x = - Δ y [ \frac{\begin{matrix}( sin θ \cdot {Γ}_{x} ( {t}_{2} ) + cos θ \cdot {Γ}_{y} ( {t}_{2} ) ) ( sin θ \frac{ⅆ {Γ}_{x} ( {t}_{2} )}{ⅆ t} + cos θ \frac{ⅆ {Γ}_{y} ( {t}_{2} )}{ⅆ t} ) + \\ ( cos θ \frac{ⅆ {Γ}_{x} ( {t}_{2} )}{ⅆ t} - sin θ \frac{ⅆ {Γ}_{y} ( {t}_{2} )}{ⅆ t} ) ( cos θ \cdot {Γ}_{x} ( {t}_{2} ) - sin θ \cdot {Γ}_{y} ( {t}_{2} ) )\end{matrix}}{\begin{matrix}( cos θ \cdot {Γ}_{x} ( {t}_{1} ) - sin θ \cdot {Γ}_{y} ( {t}_{1} ) ) ( cos θ \frac{ⅆ {Γ}_{x} ( {t}_{1} )}{ⅆ t} - sin θ \frac{ⅆ {Γ}_{y} ( {t}_{1} )}{ⅆ t} ) + \\ ( sin θ \cdot {Γ}_{x} ( {t}_{1} ) + cos θ \cdot {Γ}_{y} ( {t}_{1} ) ) ( sin θ \frac{ⅆ {Γ}_{x} ( {t}_{1} )}{ⅆ t} + cos θ \frac{ⅆ {Γ}_{y} ( {t}_{1} )}{ⅆ t} )\end{matrix}} ] \cdot \\ cos θ \frac{\frac{ⅆ {Γ}_{x} ( {t}_{1} )}{ⅆ t} - sin θ \frac{ⅆ {Γ}_{y} ( {t}_{1} )}{ⅆ t}}{sin θ \frac{ⅆ {Γ}_{x} ( {t}_{2} )}{ⅆ t} + cos θ \frac{ⅆ {Γ}_{y} ( {t}_{2} )}{ⅆ t}}\end{matrix}$$

When we assume the condition that 0=0 and that the angles of the body boundary with the contact rods provide normal (perpendicular) contact points, i.e.

$$( \frac{ⅆ {Γ}_{y} ( {t}_{1} )}{ⅆ t} = 0 , \frac{ⅆ {Γ}_{x} ( {t}_{2} )}{ⅆ t} = 0 ) ,$$

Equation 21 becomes what we expect in accordance with Equation 20, i.e.

$$Equation 22 \text{:}$$

$$\frac{Δ x}{Δ y} = - \frac{{y}_{2}}{{x}_{1}}$$

Now, let's try to find in a numerical way to describe the body boundary, i.e. the function (Γₓ,Γ_{y}), so that Δx is a linear function of Δy. Consider the first contact point. As the surface around the first contact point is convex, we can take the following definition for the function (Γₓ,Γ_{y})

$$Equation 23 \text{:}$$

$$\{ \begin{matrix}{Γ}_{x} = x \\ {Γ}_{y} = y ( x )\end{matrix}$$

For deriving the differential equation describing the shape of the boundary, we take the assumption that the angle in the contact point with the pushing rod is always zero. If (Γₓ(t₁)Γ_{y}(t₁)) is the contact point, then the local slope equals

$$( \frac{ⅆ {Γ}_{x} ( {t}_{1} )}{ⅆ t} , \frac{ⅆ {Γ}_{y} ( {t}_{1} )}{ⅆ t} )$$

and the corresponding slope at the lever will be, according to the rotation of equation 14:

$$Equation 24 \text{:}$$

$$\{ \begin{matrix}{S}_{x} = cos θ \frac{ⅆ {Γ}_{x} ( {t}_{1} )}{ⅆ t} - sin θ \frac{ⅆ {Γ}_{y} ( {t}_{1} )}{ⅆ t} \\ {S}_{y} = sin θ \frac{ⅆ {Γ}_{x} ( {t}_{1} )}{ⅆ t} + cos θ \frac{ⅆ {Γ}_{y} ( {t}_{1} )}{ⅆ t}\end{matrix} .$$

So, for having an ideal contact point pushing against the lever, we impose the condition that S_{y} should be zero. Using the definition of equation 23, the second part of equation 24 can be written as:

$$Equation 25 \text{:}$$

$$0 = sin θ + cos θ \cdot \frac{ⅆ y}{ⅆ x} or \frac{ⅆ y}{ⅆ x} = - tg θ$$

A second differential equation can be found from the fact that we want a linear object rotation as a function of the movement of the pushing rod. The y-movement at the pushing rod is given by the second term in equation 14, which changes for a elementary rotation dθ as:

$$Equation 26 \text{:}$$

$$\frac{\partial y}{\partial θ} = cos θ \cdot {Γ}_{x} + sin θ \frac{ⅆ {Γ}_{x}}{ⅆ t} \frac{ⅆ t}{ⅆ θ} - sin θ \cdot {Γ}_{y} + cos θ \frac{ⅆ {Γ}_{y}}{ⅆ t} \frac{ⅆ t}{ⅆ θ} .$$

For

$$θ = 0 and \frac{ⅆ {Γ}_{y}}{ⅆ t} = 0$$

in the contact point of the pushing rod with the body,

$$\frac{\partial y}{\partial θ} equals {x}_{1} .$$

If we constrain

$$\frac{\partial y}{\partial θ}$$

to a constant for all values of θ, then this constant value should be x₁! So, therefore, equation 26 can be written as well:

$$Equation 27 \text{:}$$

$${x}_{1} = cos θ \cdot {Γ}_{x} + sin θ \frac{ⅆ {Γ}_{x}}{ⅆ t} \frac{ⅆ t}{ⅆ θ} - sin θ \cdot {Γ}_{y} + cos θ \frac{ⅆ {Γ}_{y}}{ⅆ t} \frac{ⅆ t}{ⅆ θ} .$$

Using the definition of equation 23, this can be rewritten as:

$$Equation 28 \text{:}$$

$${x}_{1} = cos θ \cdot x + sin θ \frac{ⅆ x}{ⅆ x} \frac{ⅆ x}{ⅆ θ} - sin θ \cdot y ( x ) + cos θ \frac{ⅆ y}{ⅆ x} \frac{ⅆ x}{ⅆ θ} .$$

Taking also the constraint of equation 25 and putting this in the above equation gives:
x₁=cos θ·x−sin θ·y(x). Equation 29

This equation in fact says that the x-coordinate of the contact point should end up at the place x=x₁, which is actually the first part of equation 14.

From this algebraic equation 28, dθ/dx can be found by differentiating to x:

$$Equation 30 \text{:}$$

$$\frac{ⅆ θ}{ⅆ x} = \frac{cos θ - sin θ \frac{ⅆ y}{ⅆ x}}{x sin θ + y cos θ}$$

Using equation 25, this can be rewritten as:

$$Equation 31 \text{:}$$

$$\frac{ⅆ θ}{ⅆ x} = \frac{1}{cos θ \cdot ( x sin θ + y cos θ )}$$

We have now a set of differential equations, i.e. equation 25 and equation 31, in the two dependent variables (θ,y) with the independent variable x. This system of first order non-linear differential equations can be solved numerically, given the starting position for θ=0.

Commercial software is available for solving this non-linear system of equations, like e.g. the ode-solvers from Matlab™.

As an example, the contact shapes of a lever have been calculated by solving equation 25 and equation 31. As an input for the ode-solver, the following table lists the start positions of the shape when θ equals 0.

TABLE 1
Coordinates of the initial contact points for a specific lever design.

| | Contact point 1 | Contact point 2 |
|---|---|---|
| x-coordinate | −41.41 | 2.0 |
| y-coordinate | 4 | −5.92 |

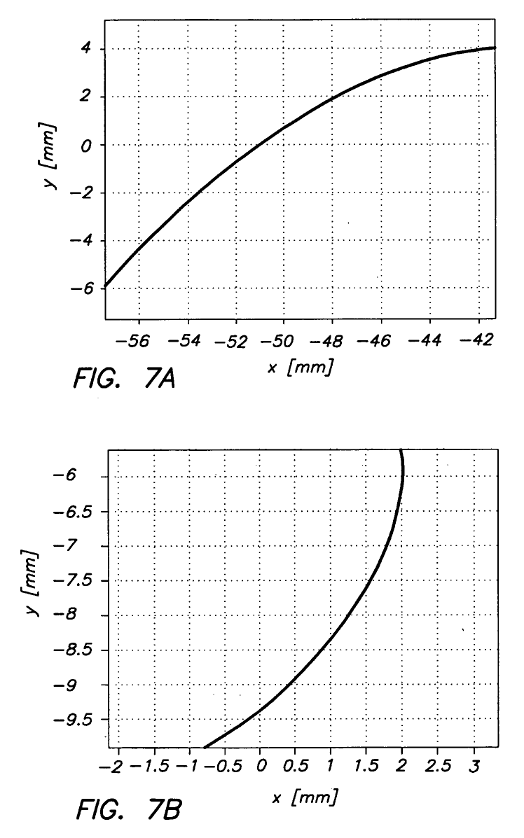

For these boundary conditions, the shape of the contact zones of the lever has been calculated numerically and depicted in FIG. 7A and FIG. 7B. FIG. 7A shows the lever contour at the pushing contact and FIG. 7B shows the contour at the load contact.

From these calculations, it turns out that there are also positions for θ which form a kind of a singular point. Beyond this singular point (or θ-value), no solution exists and it is not possible then to have a linear relationship between the y- and x-displacement. In the example, for the data of Table 1, the singular angle θ for shape 1 equals 5.5° and the singular angle for shape 2 equals −18.67°. As mentioned above, a singular angle exists when making a movement into the negative y-direction, for contact point 1, the y-coordinate of the contact point becomes zero. Further movement into the negative y-direction will produce a re-sliding of the contact rod over a part of the shape, it was sliding over before, for positive y-values. Therefore, as the rod slides over a same point of contact for 2 different y-values, it is obvious that the shape can only be designed for being correct in one y-position, but not in the other y-position. Therefore, for a good design of the lever, the working region must be chosen so that one never gets a crossing of the contact y-coordinate through the y=0 point, thus avoiding the singular point as illustrated in FIGS. 2A and 2B.

What about the conversion error from a given y-displacement in contact point 1 to a resulting x-displacement in contact point 2. Therefore, we numerically evaluate equation 21, and take into account the ideal situation of equation 22 from which we can define a factor to measure the relative accuracy of the translations of the lever as being:

$$Equation 32 \text{:}$$

$$χ = \frac{{x}_{1}}{{y}_{2}} \cdot {( \frac{Δ x}{Δ y} )}_{Eq . 10}$$

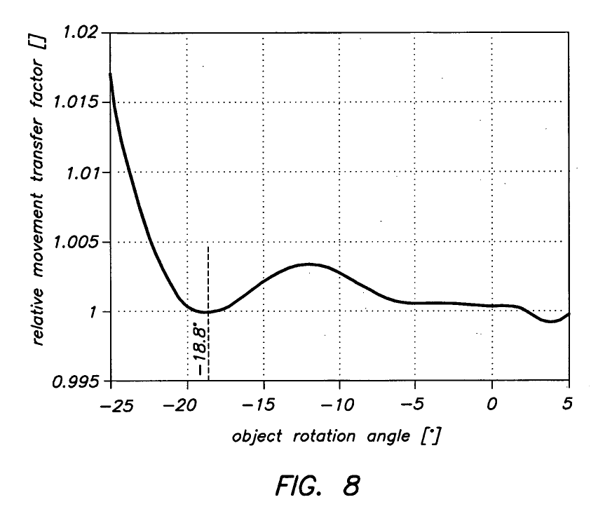

For a perfect lever operation, χ will be identical to 1. The factor χ is depicted for the example lever, according to Table 1, in FIG. 8. We notice that χ is not identical to 1 in the region between the singular angles [−18.8°, 5.5°] This is because of numerical errors in the calculations. First of all, small errors are being present because of the numerical solution of the differential equations. But the greatest numerical errors will appear from the numerical calculation of equation 21, where the d\vec{Γ}/dt terms are being estimated numerically as well. So, theoretically, χ should be 1 between the 2 singular angles, and become different from 1 outside the valid θ-interval, which can be noticed clearly from FIG. 8 when θ passes beyond the 18.8°. In the region from 0 to −20°, the maximum movement translation error equals 0.32%. It is stated that errors lower than 0.5% will result in a substantially linear behavior of the leverage system.

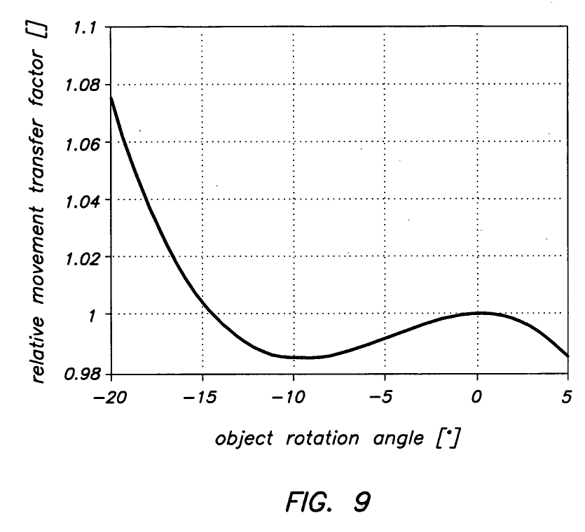

If we compare these results with a commercial design with the contact boundaries being approximated by a circle segment, corresponding χ values can be calculated as well and the resulting transfer factor is depicted in FIG. 9. We notice errors up to 7%.

B. Kinetics for Contact Points Having Two Degrees of Freedom, but Limited According to Equation 11

Instead of redoing the reasoning presented above for the case where the contact points only have one degree of freedom, the focus in this sections is only drawn to the differences and additional points of attentions to come to the boundary of an ideal lever design with limited 2-dimensional degree of freedom for the two contact points.

With reference to the body of FIG. 6 and its coordinate system, a imposed displacement of (0, Δy) on the body at boundary point t=t1 will have a additional displacement component of the boundary point in the x-direction because A now changes with the rotation angle θ of the body. The addional displacement component of the boundary point t=t1 equals Adf(θ), so that the displacement of the contact point becomes (Adf(θ), Δy). In a similar way, the resulting movement of contact point t=t2 at the body boundary equals (Δx,−Bdf(θ)), instead of (Δx,0) for a contact point having only one dimension of freedom. These considerations will change the equations 15 and 19 accordingly and will finally ends up with a relationship between Δx at t=t2 and Δy at t=t1 according to equation 33.

$$Equation 33 \text{:}$$

$$Δ x = - Δ y [ \frac{( \begin{matrix}( sin θ \cdot {Γ}_{x} ( {t}_{2} ) + cos θ \cdot {Γ}_{y} ( {t}_{2} ) ) ( sin θ \frac{ⅆ {Γ}_{x} ( {t}_{2} )}{ⅆ t} + cos θ \frac{ⅆ {Γ}_{x} ( {t}_{2} )}{ⅆ t} ) + \\ ( cos θ \frac{ⅆ {Γ}_{x} ( {t}_{2} )}{ⅆ t} - sin θ \frac{ⅆ {Γ}_{y} ( {t}_{2} )}{ⅆ t} ) ( cos θ \cdot {Γ}_{x} ( {t}_{2} ) + B \frac{\partial f}{\partial θ} - sin θ \cdot {Γ}_{y} ( {t}_{2} ) )\end{matrix} )}{( \begin{matrix}( cos θ \cdot {Γ}_{x} ( {t}_{1} ) - sin θ \cdot {Γ}_{y} ( {t}_{1} ) ) ( cos θ \frac{ⅆ {Γ}_{x} ( {t}_{1} )}{ⅆ t} - sin \frac{ⅆ {Γ}_{y} ( {t}_{1} )}{ⅆ t} ) + \\ ( sin θ \cdot {Γ}_{x} ( {t}_{1} ) + A \frac{\partial f}{\partial θ} + cos θ \cdot {Γ}_{y} ( {t}_{1} ) ) ( sin θ \frac{ⅆ {Γ}_{x}}{ⅆ t} + cos θ \frac{ⅆ {Γ}_{y} ( {t}_{1} )}{ⅆ t} )\end{matrix} )} ] \cdot \frac{cos θ \frac{ⅆ {Γ}_{x} ( {t}_{1} )}{ⅆ t} - sin θ \frac{ⅆ {Γ}_{y} ( {t}_{1} )}{ⅆ t}}{sin θ \frac{ⅆ {Γ}_{x} ( {t}_{2} )}{ⅆ t} + cos θ \frac{ⅆ {Γ}_{y} ( {t}_{2} )}{ⅆ t}}$$

When we try to find a numerical way to solve this equation, similar to the way we found a solution in the case with contact points with only one degree of freedom, we come to a set of differential equations, equation 34 and 35, in the two dependent variables (θ,y) with independent variable x.

$$Equation 34 \text{:}$$

$$0 = sin θ + cos θ \cdot \frac{ⅆ y}{ⅆ x} or \frac{ⅆ y}{ⅆ x} = - tg θ$$

$$Equation 35 \text{:}$$

$$\frac{ⅆ θ}{ⅆ x} = \frac{1}{cos θ \cdot ( {x}_{1} \frac{ⅆ f}{ⅆ θ} + x sin θ + y cos θ )}$$

The function f(θ) is known or should be known and is not a part of the solution. This system of first order of non-linear differential equations can be solved numerically, given the starting position for θ=0. Commercially, software is available for solving this non-linear system of equations, like e.g. the ode-solvers from Matlab™.

As an example, the contact shapes of the body, i.e. the lever have been calculated by solving equation 34 and 35. As an input for the ode-solver, the following table lists the start positions of the shape when θ equals 0.

TABLE 2
Coordinates of the initial contact points for a specific lever design.

| | Contact point 1 | Contact point 2 |
|---|---|---|
| x-coordinate | −41.41 | 2.0 |
| y-coordinate | 4 | −5.92 |

For f(θ), we take a linear function, being:
f(θ)=1+a·θ_{[ ]}, Equation 36
with a=1 [rad⁻¹], in the following numerical example for contact point 1. For contact point 2, we solve the identical differential equation, but we know that we have to interchange in the solution x and y, as the contact surfaces need to ly perpendicular to each other. For the constant a in equation 32, we have to take a value of −1 [rad⁻¹] to copy with this interchange of x- and y-coordinates.

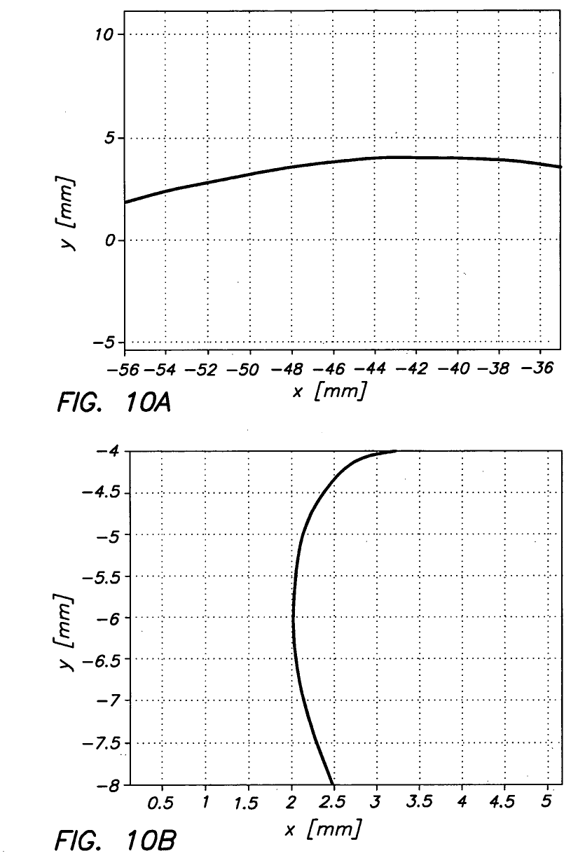

For these boundary conditions, the contact shape of the lever has been calculated numerically and are being depicted in FIGS. 10A and 10B. To our surprise, we notice that the shape in 10B is convex and it is not so obvious to push with a lever against this shape. The lever will need a special construction in order to follow the shape at its back side.

In both the cases it is clear that the butting surfaces of the levers are formed by the union of the contact points defined by the solution of the boundary value problem.

The main purpose of a lever design according to the invention is to obtain linearity in the ratio of the movement of the adjustment means and the movement of the positioning device relative to a base plate.

A further object is that the forces acting upon the lever are always perpendicular to the contact surface and the ratio of the length of the load arm to the length of the force arms is kept constant. As described above the working distance D has to be in between the singular point of the positioning system as described above.

Practical Embodiment of a Lever Design According to the Invention in Printhead Positioning Devices

The defined lever shapes can be put to practice in a positioning system for printheads, e.g. inkjet printheads.

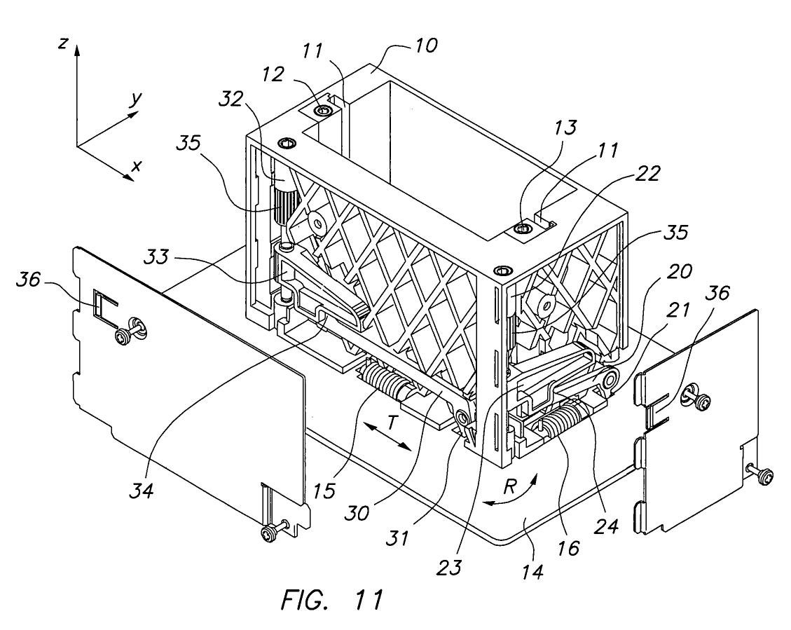

Following practical example is given in relation to FIG. 11.

Referring to FIG. 11 the positioning system used for positioning a printhead includes features described below. In the description following the printhead positioning device 10 will be abbreviated as HPD.

Fixing of the printing head, not shown, in the HPD 10 and positioning of the printing head in the Z-direction is realized using splines fitting in grooves 11. By tightening the screws 12, 13, the associated splines move downward and pushed the printing head's Z-datum against a base plate 14 which is common for all printing heads, while at the same time clamping the printing head into a fixed position within the HPD 10. All printing heads have a common Z-reference, being the single base plate 14. The base plate 14 has several cut-outs of which one is for receiving the front side of the printing head, including a nozzle plate with marking elements, so that the marking elements extend through the base plate 14.

The HPD 10 is fixed in the Z direction but can move relatively to the base plate 14 in the X direction to align the printing head with a print swath and can rotate with only an y-translation of the marking elements of the printhead to align the printing head substantially orthogonal to the printing direction an indicated by the arrows T and R.

By use of two anti-play springs 15 and 16 the HPD is pressed in X and Y direction at one side of other cut-outs in the base plate so that the edges of these cut-outs in the base plate come in contact with two dedicated levers 20 and 30.

The first dedicated lever 20 acts in the Y-direction and can move the HPD 10 (including the locked printing head) so that the marking elements of the printing head experience a displacement that is a function of the position of the marking element in the array of marking elements and is aimed at rotating the array of marking elements until an orthogonal position, with respect to the printing direction, is achieved. The lever 20 contacts the base plate 14 at contact point 21 and it can be set using adjustment screw 22 which is coupled to the lever 20 by a intermediate slider 23 contacting the lever at contact point 24.

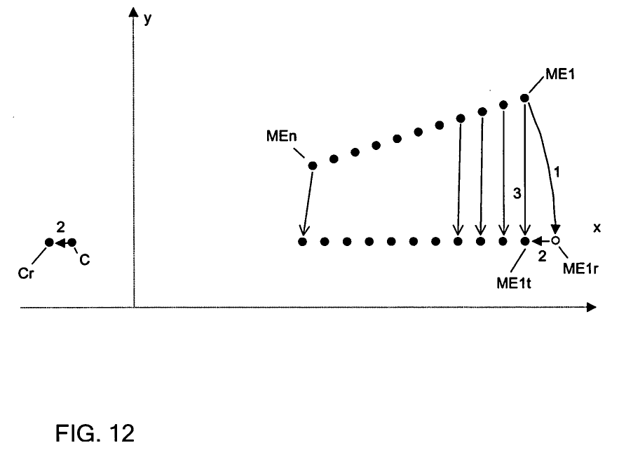

By turning the adjustment screw 22 up or down, a movement is given on the force arm of the first lever 20 via the contact point 24 and the lever 20 rotates around a fixed rotation point on the HPD frame, pushing the load arm against one side of a cut-out in the base plate 14 at contact point 21, against the force of the spring 16. If the HPD 10 were to be fixed to the base plate 14 in a single point, this single point would be a rotation point of the HPD 10 (including the locked printing head) as a result of the force exercised in contact point 21 by lever 20. By rotating, the array of marking elements not only rotate but also slightly translate in the X direction. This effect is not desired because this translation in the X direction interferes with the x-position adjustment of the printing head using a second dedicated lever, to be discussed further in this description. One solution to solve this problem is to have the rotation point of the HPD 10 slide along the X-axis so that a rotation R is substantially transformed into a translation along the Y-axis, at least for one marking element that is used as a reference element in the alignment process, and the mutual interference between the two position adjustment means of the HPD is undone. This is illustrated in FIG. 12. The figure clearly shows that a rotation around a translating rotation point can realize a single non-uniform translation (different magnitudes) substantially along the Y-axis for a majority of marking elements, without changing their x-position. In FIG. 12 rotation point c translates along the x-axis according to solid arrow 2 while the marking elements ME1 to MEn rotate around the rotation point c according to solid arrow 1. The combined rotation 1 and translation 2 results in a translation 3 of the marking elements that is substantially parallel to the y-axis (see open arrows on FIG. 12), at least for a reference marking element, e.g. ME1, that is used in the printing head positioning process to measure the initial positioning error of the printing head on a test print. Using the possibility to slide the rotation point, the position adjustment using lever 20 can be made to not interfere with the position adjustment using lever 30 discussed further in this description, provided the proper marking elements are used to calculate the adjustments based on a test print.

The second dedicated lever 30 acts in the X-direction and moves the HPD 10 (including the locked printing head) so that all marking elements of the printing head experience a uniform translation (same magnitude) in the X-direction. This adjustment allows for correctly butting of multiple arrays of marking elements in the X-direction (i.e. side-by-side). The lever 30 contacts a side of a cut-out in the base plate 14 at contact point 31 and it can be set using adjustment screw 32 which is coupled to the lever 30 by a intermediate slider 33 contacting the lever at contact point 34. By turning the adjustment screw 32 up or down, a movement is given on the force arm of the second lever 30 via the contact point 34 and the lever 30 rotates around a fixed rotation point on the HPD frame, pushing the load arm against the side of the cut-out in the base plate 14 at contact point 31 against the force of the spring 15. The HPD 10 is hereby translated as is also the array of marking elements of the locked printing head as a whole.

So far, multiple arrays of marking elements may be aligned parallel to the X-axis and positioned along the x-axis, using the HPD's described above. The alignment of multiple arrays of marking elements in de Y-direction is done via electronic control means (i.e. timing of marking element activation pulses).

The surface shapes of the contact points 16, 19, 21, 24 of both dedicated levers 15, 20 comply with the constraints as described above, needed to obtain linear and thus predictable displacement of a HPD with reference to precise cut-outs in a base plate.

The main advantage of having a proportional relationship between the driving action of the adjustment means (rotation of a screw by the operator) and the driven response of the positioning device (displacement of the printing head relative to the mounting base plate) is that methods to align printing heads after their initial position has been detected only requires a few corrective actions. In a first step the initial position of the printing head can be detected for example by use of a test print. The test print can be designed so that position errors are easily deducted or may be just readable from the print. Matching sets of lines from different printing heads may indicate directly deviation angles and distances from ideal placement. First the angular deviation from parallelism with the x-axis is measured and converted to a displacement of lever 20 via adjustment screw 22, and secondly the position error along the x-axis is measured. It may be advantageous in this position error measuring step to use a reference marking element of the printing head furthest away from the HPD rotation point and closest to lever 20 to determine both adjustments. See also the comments to FIG. 12. When the deviation is known and as the displacement of the adjustment means is linear it is easy to perform adjustment of the printing head(s) manually by the operator. First the array of marking elements can be adjusted parallel to the x-axis by adjusting the adjustment screw 22. The required translation along the X-axis can then be performed by adjustment of screw 32.

The accessibility of all printing head replacement and adjustment means at one side of the HPD allows fast and easy replacement and alignment of a printing head in the event of malfunction of the printing head. No special service tools or skills are required to replace and align printing heads; the procedure can be executed by a printer operator.

In the depicted embodiment of FIG. 11 the screws are in fact more a complicated spindle system totally traversing the HPD from top to bottom. On these spindles the intermediate sliders 23,33 are mounted and these are moved up or down when turning the spindles assembly.

The top to bottom spindles provide the extra advantage that there is a possibility to adjust the screw/spindle assembly from the top as well as from the bottom if fitted with e.g. a socket head ending at both sides.

This makes that the single design of the head positioning device can be put to use in more versatile conditions.

The accessibility of all the alignment and mounting means from the top and the accessibility of the alignment means from the bottom helps to keeping maintenance costs low.

Note that it is important that the actual position adjustment, i.e. the movement of the “actuators” of the adjustment mechanisms needs to be located near the front of the printing head where the marking elements are located. Indeed, the position of the marking elements is mapped to printed marking points on the receiving substrate and thus the position of the marking elements, amongst other aspects, determines the print quality.

The adjustment screws are preferably of a self-locking type.

A possible embodiment uses screws that are equipped with a locking mechanism in which a small metal sphere is pressed onto a toothed ring by a small spring. In the depicted embodiment of FIG. 11, the screws have a toothed section 35 which is contacted by a kind of leaf spring 36 which is cut out in the respective cover plates closing the side of the HPD.

As a result of these extra features, a full rotation of the screw is divided in several clicks. Each time the metal sphere or leaf spring 36 is pressed into a next tooth of the toothed section 35. This allows for an even better control of the rotation of the adjustment screw, i.e. each click represents an equal rotation angle that is transformed by the lever into an equal translation of the marking elements of the printing head. One of the obvious advantages of self-locking adjustment means is that the position of the printing head is secures at all times. Drift of the adjustment means due to vibrations internal or external to the printer, or accidental exposure to unwanted influences or forces are eliminated. Using the system, an incremental small rotation of one click is first transformed into an even smaller downward movement of the screw, depending upon the pitch of the thread of the screw, and is secondly transformed into a minute displacement of the HPD (including the locked printing head) by using the levers.

In stead of springs 15, 16 other types of resilient means can be used to urge the mounting element on the frame or the frame itself in contact with the lever. Other types may be e.g. resilient rubber parts.

As the printing head is fixed in the head positioning device and the device is adjustably mounted on the base plate, the mounting features of the printhead can be made simple and cheap. This makes replacement of a printing head also less expensive.

The printing head positioning system according to this invention is suitable for scanning printing systems whereby the printing heads shuttle back and forth across the width of the recording medium while the recording medium is transported along the length direction. However, the printing head positioning system is also suitable for page wide printing systems whereby the printing heads are stationary and cover part or the complete width of the recording medium while the recording medium is transported in along the length direction. As the head positioning device is carried on the base plate and may be shuttling back and forth across the recording medium, preferably the head positioning device is made of a light material putting less strain on the shuttling mechanism. Less inertia poses less problems. It should however be as strong as well to avoid deformation due to the repeating accelerations as the shuttle starts and stops.

As can be seen from FIG. 11, in the example the walls of the head positioning device may be made of a synthetic material having a grid-like or honeycomb structure having high strength but low weight.

It has already been discussed that the preferred location where the position adjustments of the printing head or HPD are done, i.e. as close as possible to the marking elements, is not necessarily the most accessible location for an operator to perform the adjustments. Therefore the invention provides a way to lead the access point for the adjustment means away from the adjustment action itself, via a lever and elongated screw, so as to make adjustments easily accessible for an operator. The same principle may also be applied to printing head connections that are required near the front of the printing head and are difficult to access once the printing head is mounted in the printing system. One examples may be a connection of the printing head to a cooling circuit for cooling the marking elements of the printing head, as provided near the front of the first generation of XJ500 ink jet printing head from Xaar plc—Cambridge (UK). Another example may be the ink connection of XJ128 printing heads from Xaar plc—Cambridge (UK), that is located on top of the printing head near the front where the marking elements are located. Still another example may be the lung mechanism for ink de-aeration incorporated in Galaxy type printing heads from Spectra Inc—Lebanon N.H. (USA), where the vacuum connection to the lung mechanism is located near the front of the printing head. All these connections are difficult to access once the printing head is mounted in the printing apparatus. Therefore it may be advantageous to design extension pieces for these connections into the HPD so as to lead the printing head's connection point near the front to a side of the HPD that is easily accessible for making and breaking connections, for example at the back of the HPD where also the adjustment means for printing head positioning are located. The connection extension pieces preferably are provide with proper fittings at the side of the connection with the printing head so as to seal the hydraulic connection when the printing head is inserted in the HPD and fixed into the HPD by means if the splines discussed previously. At the other side of the connection extension pieces, i.e. the accessible side of the connection, e.g. at the back of the HPD, any connection type may be used but an easy operated connection is preferred. The use of lever systems for positioning of the printing head or HPD with reference to a base plate and the use connection extension pieces to make hydraulic connections near the front of the printing head allow all connections with the printing head, that need to be accessible for operator intervention, to be diverted to the easiest accessible side of the HPD.

Having described in detail preferred embodiments of the current invention, it will now be apparent to those skilled in the art that numerous modifications can be made therein without departing from the scope of the invention as defined in the appending claims.

1. A positioning system for accurately positioning an element relative to a frame comprising:
a positioning device, adjustably mounted on said frame or carrying said element mounted in the positioning device,
an adjustment means, adjustable over a working distance D for setting the position of the positioning device relative to the frame and making a first sliding butting contact to
a lever making a second sliding butting contact to the positioning device on the frame or frame itself for transferring movement of the adjustment means over a distance Δx into a corresponding movement of the positioning device relative to the frame over a distance Δy,
characterized in that ratio Δx/Δy is substantially constant for movements within the working distance D.

2. The positioning system according to claim 1 wherein the forces acting upon the lever by the adjustment means and by the positioning device are always perpendicular to the butting surface of the lever.

3. The positioning system according to claim 1 wherein the ratio of the length of the load arm to the length of the force arm of the lever is constant.

4. The positioning system to claim 1 wherein the butting surfaces of the lever are formed by the union of contact points defined by the solution of the boundary value problem:
$$\{ \begin{matrix}0 = sin θ + cos θ \cdot \frac{ⅆ y}{ⅆ x} or \frac{ⅆ y}{ⅆ x} = - tan θ \\ \frac{ⅆ θ}{ⅆ x} = \frac{1}{cos θ ( {x}_{1} \frac{ⅆ f}{ⅆ θ} + x sin θ + y cos θ )}\end{matrix}$$
wherein Δx is a linear function of Δy and wherein
x=value of a boundary point along the abscissa.
θ=angle position of the lever
y=coordinate describing shape of the lever as function of the local coordinate x.

5. The positioning system according to claim 4 wherein the working distance D is situated in between singular working points of the lever mechanism.

6. The positioning system according to claim 1 wherein the angle between the contact points of the load arm, the rotation point and the contact point of the force arm is constant.

7. The positioning system according to claim 1 wherein the adjustment means and rotation point of the lever are mounted on the positioning device and the second butting contact is in contact with the frame.

8. The positioning system according to claim 1 wherein a resilient means urges the positioning device on the frame or the frame itself in contact with the lever.

9. The positioning system according to claim 1 wherein the element mounted on the positioning device is a printhead.

10. An inkjet printer comprising at least one printhead mounted on a positioning system according to claim 1.
